(19) United States
(12) Patent Application Publication
(10) Pub. No.: US 2014/0358621 A1
(43) Pub. Date: Dec. 4, 2014

(54) TIME-DEPENDENT REORDER POINTS IN SUPPLY CHAIN NETWORKS

(71) Applicant: International Business Machines Coproration, Armonk, NY (US)

(72) Inventors: Anthony Bussani, Rueschlikon (CH); Soojung Hong, Canton (CH); Ban Kawas, Irvington, NY (US); Tim Nonner, Canton (CH); Manuel Parente, Williston, VT (US); Jean-Philippe Pellet, Penthalaz (CH); Ulrich Schimpel, Hirzel (CH); Satyadeep Vajjala, South Burlington, VT (US); Stefan Woerner, Zurich (CH)

(73) Assignee: International Business Machines Coproration, Armonk, NY (US)

(21) Appl. No.: 14/021,428

(22) Filed: Sep. 9, 2013

Related U.S. Application Data
(63) Continuation of application No. 13/903,660, filed on May 28, 2013.

(51) Int. Cl. G06Q 10/06

(52) U.S. Cl. CPC G06Q 10/06315
USPC 705/7.25

(57) ABSTRACT

According to an exemplary embodiment, a computer-implemented method for attempting to optimize a supply chain network (SCN) includes forecasting demand in the SCN based on a set of demand data. One or more time-dependent reorder points (ROPs) deemed to optimize the SCN are generated by a computer processor, based on the demand forecast, where each time-dependent ROP represents an ROP that changes over time. A simulation of operations of the SCN is performed, using the time-dependent ROPs.

### CROSS REFERENCE TO RELATED MATTER

This application is a continuation of U.S. patent application Ser. No. 13/903,660 filed May 28, 2013, the disclosure of which is incorporated by reference herein in its entirety.

### BACKGROUND

Various embodiments of this disclosure relate to supply chain networks and, more particularly, to optimizing supply chain networks by using time-dependent reorder points.

Production and distribution supply networks in the semiconductor industry are asset intensive. Consequently, a high utilization is crucial for such networks to remain economical. The industry is characterized by a high stochasticity in customer demand and production yield and by a high complexity in the production process, which includes joint capacity restrictions and multi-sourcing. Difficulties arise because of the following issues, along with others: time-dependent stochastic demand, time-dependent available capacity; capacity being shared among competing products; and interdependency between the different stages. Usually deterministic or strongly simplified approaches are used in attempts to optimize these networks, but these approaches produce results that may be immediately obsolete after being executed in reality. This effect is known as the “gap” between planning and execution.

### SUMMARY

In one embodiment of this disclosure, a computer-implemented method for attempting to optimize a supply chain network (SCN) includes forecasting demand in the SCN based on a set of demand data. One or more time-dependent reorder points (ROPs) deemed to optimize the SCN are generated by a computer processor, based on the demand forecast, where each time-dependent ROP represents an ROP that changes over time. A simulation of operations of the SCN is performed, using the time-dependent ROPs.

In another embodiment, a system includes a forecast unit, an optimization unit, and a simulation unit. The forecast unit is configured to forecast demand in an SCN based on a set of demand data. The optimization unit is configured to generate, with a computer processor, one or more time-dependent ROPs deemed to optimize the SCN based on the demand forecast, where each time-dependent ROP represents an ROP that changes over time. The simulation unit is configured to simulate operations of the SCN using the time-dependent ROPs.

In yet another embodiment, a computer program product includes a computer readable storage medium having computer readable program code embodied thereon. The computer readable program code is executable by a processor to perform a method for attempting to optimize an SCN. The method includes forecasting demand in the SCN based on a set of demand data. Further according to the method, one or more time-dependent ROPs deemed to optimize the SCN are generated by a computer processor, based on the demand forecast, where each time-dependent ROP represents an ROP that changes over time. A simulation of operations of the SCN is performed, using the time-dependent ROPs.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a computing device for implementing some aspects of an optimization system for a production and supply chain network (SCN) according to an exemplary embodiment of this disclosure;

FIG. 2 is a block diagram of the optimization system, according to an exemplary embodiment of this disclosure;

FIGS. 3A-3C are tables illustrating demand forecasts with consideration of potential error;

FIG. 4A is a table illustrating a variable capacity restriction for a component being produced by an SCN;

FIGS. 4B-4D are tables further illustrating demand forecasts with consideration of potential error, based on the capacity restriction of FIG. 4A;

FIG. 5 is a flow diagram of a method 500 for attempting to optimize an SCN, according to an exemplary embodiment of this disclosure; and

FIGS. 6A-11 illustrate results of attempting to optimize an SCN using four different techniques, one of which being an exemplary embodiment of this disclosure.

### DETAILED DESCRIPTION

Various embodiments of this disclosure are optimization systems, methods, and computer program products that seek to optimize operations of a production and supply chain network (SCN). While the embodiments may be particularly useful in the semiconductor industry, they are not limited to this industry.

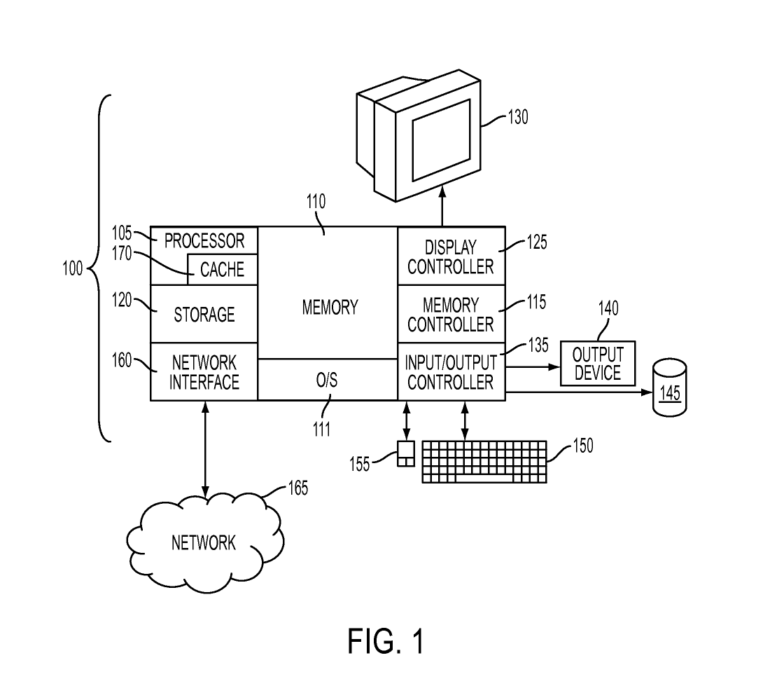

FIG. 1 illustrates a block diagram of a computer system 100 for use in implementing an optimization system or method according to some embodiments. The optimization systems and methods described herein may be implemented in hardware, software (e.g., firmware), or a combination thereof. In an exemplary embodiment, the methods described may be implemented, at least in part, in hardware and may be part of the microprocessor of a special or general-purpose computer system 100, such as a personal computer, workstation, minicomputer, or mainframe computer.

In an exemplary embodiment, as shown in FIG. 1, the computer system 100 includes a processor 105, memory 110 coupled to a memory controller 115, and one or more input and/or output (I/O) devices 140 and 145, such as peripherals, that are communicatively coupled via a local I/O controller 135. The I/O controller 135 may be, for example but not limitation, one or more buses or other wired or wireless connections, as are known in the art. The I/O controller 135 may have additional elements, which are omitted for simplicity, such as controllers, buffers (caches), drivers, repeaters, and receivers, to enable communications.

The processor 105 is a hardware device for executing hardware instructions or software, particularly those stored in memory 110. The processor 105 may be any custom made or commercially available processor, a central processing unit (CPU), an auxiliary processor among several processors associated with the computer system 100, a semiconductor based microprocessor (in the form of a microchip or chip set), a macroprocessor, or other device for executing instructions. The processor 105 includes a cache 170, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 170 may be organized as a hierarchy of more cache levels (L1, L2, etc.).

The memory 110 may include any one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, or other types of storage media. Note that the memory 110 may have a distributed architecture, where various components are situated remote from one another but may be accessed by the processor 105.

The instructions in memory 110 may include one or more separate programs, each of which comprises an ordered listing of executable instructions for implementing logical functions. In the example of FIG. 1, the instructions in the memory 110 include a suitable operating system (OS) 111. The operating system 111 essentially may control the execution of other computer programs and provides scheduling, input-output control, file and data management, memory management, and communication control and related services.

Additional data, including, for example, instructions for the processor 105 or other retrievable information, may be stored in storage 120, which may be a storage device such as a hard disk drive.

In an exemplary embodiment, a conventional keyboard 150 and mouse 155 may be coupled to the I/O controller 135. Other output devices such as the I/O devices 140 and 145 may include input devices, for example but not limited to, a printer, a scanner, a microphone, and the like. The I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like.

The computer system 100 may further include a display controller 125 coupled to a display 130. In an exemplary embodiment, the computer system 100 may further include a network interface 160 for coupling to a network 165. The network 165 may be an IP-based network for communication between the computer system 100 and any external server, client and the like via a broadband connection. The network 165 transmits and receives data between the computer system 100 and external systems. In an exemplary embodiment, the network 165 may be a managed IP network administered by a service provider. The network 165 may be implemented in a wireless fashion, e.g., using wireless protocols and technologies, such as WiFi, WiMax, etc. The network 165 may also be a packet-switched network such as a local area network, wide area network, metropolitan area network, the Internet, or other similar type of network environment. The network 165 may be a fixed wireless network, a wireless local area network (LAN), a wireless wide area network (WAN) a personal area network (PAN), a virtual private network (VPN), intranet or other suitable network system and may include equipment for receiving and transmitting signals.

Systems and methods according to this disclosure may be embodied, in whole or in part, in computer program products or in computer systems 100, such as that illustrated in FIG. 1.

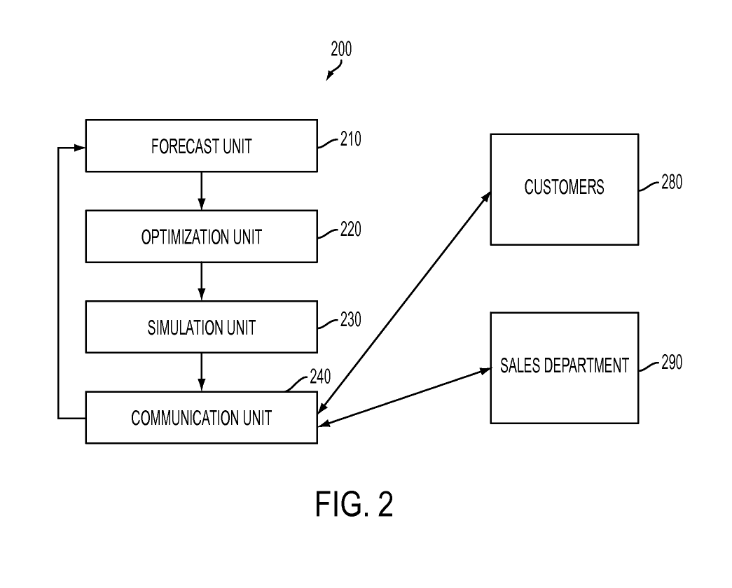

FIG. 2 illustrates a block diagram of an optimization system 200, according to an exemplary embodiment of this disclosure. The optimization system 200 may seek to generate a set of one or more time-dependent reorder points (ROPs) that optimize operations of an SCN, where each time-dependent ROP may be represented as a time-series of ROPs.

As shown, the optimization system 200 may include a forecast unit 210, an optimization unit 220, a simulation unit 230, and a communication unit 240. In general, the optimization system 200 may perform the following activities: calculate demand forecasts and forecast errors in a robust manner, such as by anticipating and preparing for a worst-case scenario; plan production to produce ROPs while considering a non-stationary, stochastic demand model, time-dependent joint capacity constraints, and interdependencies between stages; and simulate a network respecting various business logics (e.g., Kanban, lot size, etc.) on a detailed level. These activities may be repeated until a set of one or more predetermined conditions is met, where each performance of the activities may be modified based on results of a prior simulation. This entire set of processes, including the repetitions until the predetermined condition is met, may be rerun periodically based at least in part on feedback received from others, such as customers, suppliers, and a sales department. An advantage of some embodiments of the optimization system 200 is the capability of handling non-stationary, interdependent processes.

An exemplary optimization system 200 may reduce the gap between planning and execution in a complex, highly stochastic SCN. This may be achieved by using time-dependent ROPs to handle time-dependent demands and capacity constraints, along with robust optimization techniques to cover uncertainty in those demands.

The forecast unit 210 of the optimization system 200 may analyze demand data, which may be historical data related to past demand, orders already place, and prior simulations. Based on the forecast unit's analysis, the optimization unit 210 may generate an optimization problem, the solution to which is a set of time-dependent ROPs based on a demand forecast that may incorporate a worst-case potential error.

While some embodiments of the forecast unit 210 may use only a deterministic approach, assuming that the resulting forecast is correct until shown otherwise, some other embodiments may assume that a forecast error exists. In that case, the forecasted demand may be considered in conjunction with an uncertainty set representing potential forecast error. From this demand data, including or excluding the forecast error depending on implementation, the forecast unit 210 may generate a demand model forecasting future demand.

In some embodiments, the demand model may incorporate a deterministic demand forecast together with a corresponding sequence of random distributions or uncertainty sets. The random distributions or uncertainty sets may later be incorporated into the optimization problem solved by the optimization unit 220, and may provide a potential error in the demand forecast deemed to be the worst-case error.

A straight-forward approach for adding the forecast error to a demand model would be to determine a total potential error and to spread that total across the entire time horizon being considered. In contrast, exemplary embodiments may place the potential error at specific time points in order to create a worst-case forecast, and to optimize the SCN based on this worst-case forecast. In other words, an uncertainty set may be generated corresponding to a scenario deemed to be the worst case, where each point in the uncertainty set represents the potential forecast error at a given time. This “worst case” may reflect not only the local situation but also some or all of the SCN, including its dependencies and the ROPs being generated. Because the worst case situation is likely to change as the ROPs are updated, exemplary embodiments of the optimization unit 210 may solve for the time-dependent ROPs while simultaneously determining the worst-case error.

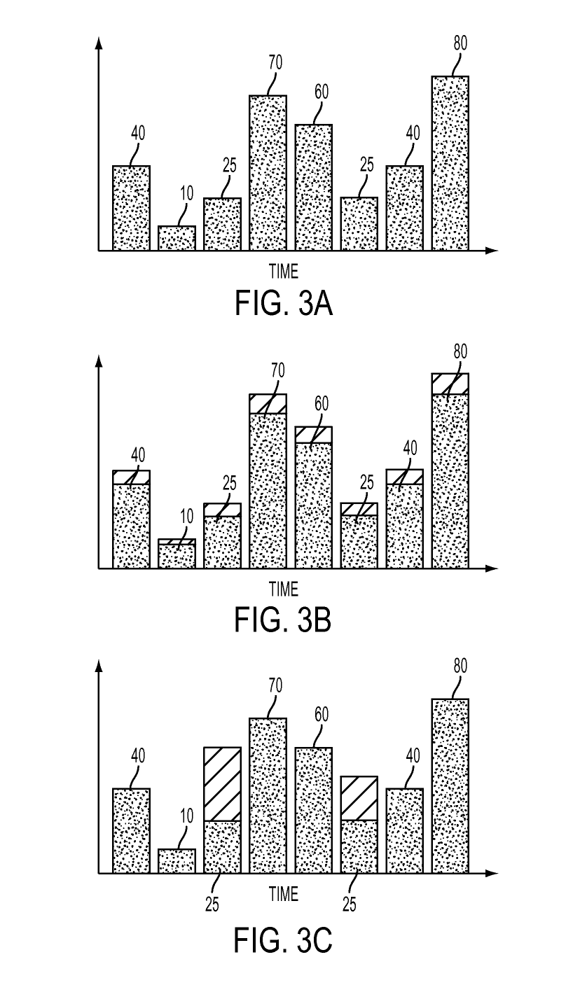

FIGS. 3A-3C are graphs illustrating various means of demand forecasting. FIG. 3A shows an example time-dependent forecast, without regard to potential error. FIG. 3B illustrates a simple means of adding potential error to the demand forecast, in which the potential error is added proportionately to each time point. This estimation of error can be too optimistic. In contrast, some exemplary embodiments enable potential error to be specified more precisely, at specific points in time. FIG. 3C represents an example of this, adding the potential error to only two specific time points. The time points at which this potential error is added may be selected based on the demand data, so as to represent demand that would be hardest to meet given the characteristics of the SCN. As compared to FIG. 3B, the total potential error may be the same in FIG. 3C, but it may be added at the worst times for receiving new orders.

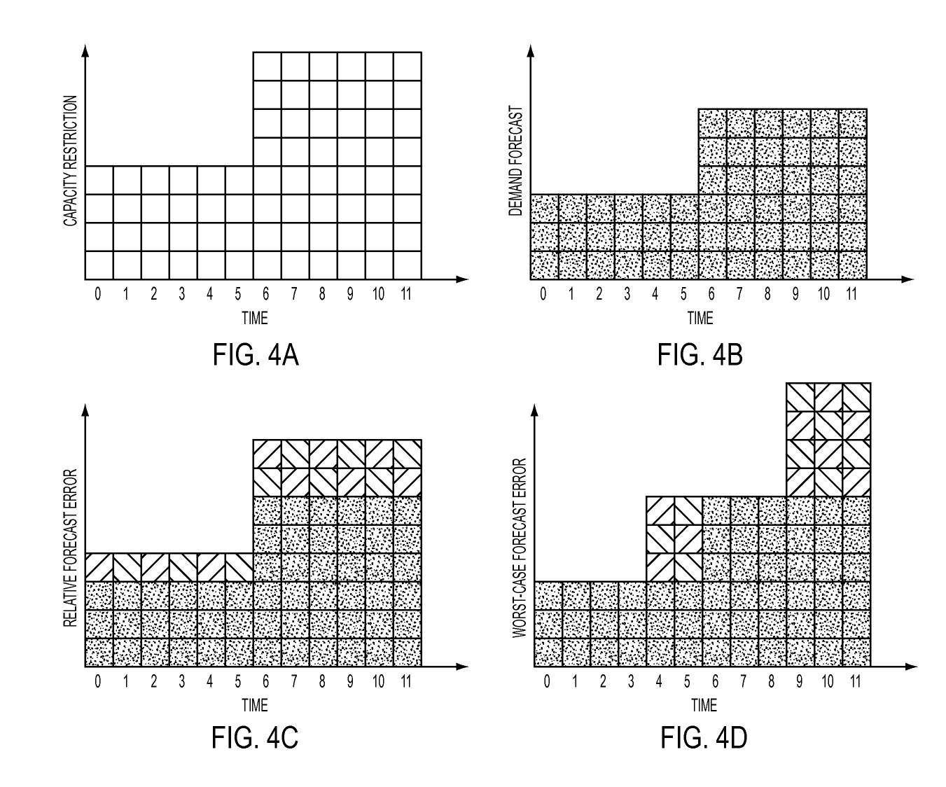

FIGS. 4A-4D further illustrate the incorporation of the uncertainty sets into the demand forecast. FIG. 4A illustrates example capacity restrictions for production of Product P1. FIG. 4B illustrates the deterministic demand forecast (i.e., the forecast as determined, without potential forecast error being included) for Product P1. FIG. 4C shows another forecast for Product P1, based on the deterministic forecast of FIG. 4B but also including a proportionately applied error. In contrast, FIG. 4D illustrates application of a worst-case error added to FIG. 4B, according to some exemplary embodiments. As shown in FIG. 4D, adding the potential error may be performed time-dependently. As a result, the time-dependent ROPs may be generated based on more specific worst-case scenarios than are provided in conventional optimization systems 200.

The time points where the potential error is added may be determined in various ways. For example, and not by way of limitation, the potential forecast error may be added to coincide with the highest forecasted demand, with the most stringent capacity restrictions, or at times where the capacity restrictions are about to change. In some exemplary embodiments, the time horizon may be split into two approximately equal forecast error periods. The total potential forecast error may be added proportionately to each half of the time horizon. Instead of the error being spread throughout each half, however, the potential forecast error for that half may be added toward the end of the respective half of the time horizon. Further restrictions may be used, such as setting a maximum for the amount of potential error added at each time point. FIG. 4D uses this example mode of error forecasting, where 6 units of error are added to the first half of the time horizon with a maximum of three units in a given period, and where 12 units are added to the second half of the time horizon with a maximum of 4 units per period. Although this disclosure refers to error in absolute terms, e.g., in units, it will be understood that error may be measured in various other ways, such as in relative terms (e.g., percentage). In practice, with respect to inventory backlogs, it can be shown that ROPs generated by embodiments of this disclosure are superior when time-dependent error is added to the forecasts, as opposed to proportional error.

The forecast unit 210 may incorporate the deterministic demand forecast as well as a representation of a worst-case scenario into is demand model. Using this demand model and other inputs related to the SCN (e.g., bill of material, supplier and production parameters), the optimization unit 220 may generate a tractable optimization problem, which may consider the time-dependencies of demands, capacity restrictions on each component being produced, and capacity constraints across all components. The optimization problem may but need not, however, consider business-relevant key performance indicators (KPIs) (e.g., service level, revenue) or stochastic disturbances.

The optimization problem may be solvable by standard mathematical programming software, such as CPLEX®. The solution may be, for each component for which an ROP is sought, a time-dependent ROP. Each time-dependent ROP may be series of ROPs, where each ROP in the series indicates a target number of units for the respective component at a given time, below which additional units are to be ordered for production. An ROP may be time-dependent in that it changes over time, indicating varying reorder guidelines at various time periods. The time-dependent ROPs of an exemplary embodiment may provide a performance improvement over conventional SCN optimization. It will be understood that the data structure representing an ROP may be predefined and dependent on the system usage and implementation.

After solving the optimization problem, the resulting ROPs and SCN parameters may be fed into the simulation unit 230, which may perform a stochastic evaluation of the solution (i.e., the time-dependent ROPs) under consideration of various relevant business rules. The simulation unit 230 may additionally estimate one or more KPIs of interest, such as revenue, utilization, and others.

The simulation unit 230 may output a set of simulation results, which may provide instructions about, for example, what units are available at what time and when orders will be fulfilled. The simulation unit 230 may use a predetermined condition, or set of conditions, to determine whether the simulation is successful. For example, the condition may require a certain percentage of orders to be fulfilled on time. The simulation unit 200 may deem the simulation a success if the predetermined condition is satisfied; otherwise, the simulation may be deemed unsatisfactory and unsuccessful. In an exemplary embodiment, the predetermined condition may be chosen such that simulation results are deemed unsatisfactory in the case of inadequate representation of the interdependent demands throughout the SCN. In this case, the difference between the represented demand and the actual demand may be added to the demand model.

If the simulation results are unsatisfactory, the optimization system 200 may apply a feedback loop to adapt the demand model (e.g., including worst-case forecasting) and the optimization problem and iterate between optimization and simulation until a solution is found that the simulation unit 230 deems satisfactory, or until a threshold condition has been met. The threshold condition may indicate when the loop should stop, even if a satisfactory solution was not found. For example, and not by way of limitation, the threshold condition may indicate that the loop may be performed no more than a predetermined number of times, or may be performed until the improvement from the prior iteration is less than a predetermined degree of improvement.

If the simulation results are satisfactory, the communication unit 240 may use the simulation results to perform various tasks, including, for example: generating new supply orders, generating orders to reduce safety stocks, sending order forecasts to the external suppliers, and sending forecasts to the customers or the sales department. Suppliers or other entities who receive reports or instructions based on the ROPs or the simulations results may provide feedback to the communication unit 240. This feedback may include, for example, updates to supplier or production parameters or new or revised order placement. The feedback may present new issues to be considered, which may be incorporated into the demand data. With the updated demand data, the forecasting, optimizing, and simulations may be repeated to output a new set of ROPs and simulation results, including any iterations needed for the rules to be satisfied by the simulation results.

The optimization system 200 may repeat the process of forecasting, optimizing, simulating, and repeating the optimizing and simulating as necessary whenever a new solution is sought based on updated demand data. Because of the time-dependent nature of the variables involved, a fixed set of time-dependent ROPs can prove problematic, as it may be beneficial to have ROPs that can be adjusted as more information is received. Having daily-changing ROPs may not be feasible for manufacturing companies because these may be too complicated to communicate to the involved parties. Thus, in an exemplary embodiment, the set of ROPs may be changeable, but an ROP period may be used to specify how often the ROPs are allowed to change, as well as to specify the start of each ROP period during which a single change may be allowed. For example, an ROP period may indicate that ROPs can change weekly for an operational week starting on Saturday and ending on Friday.

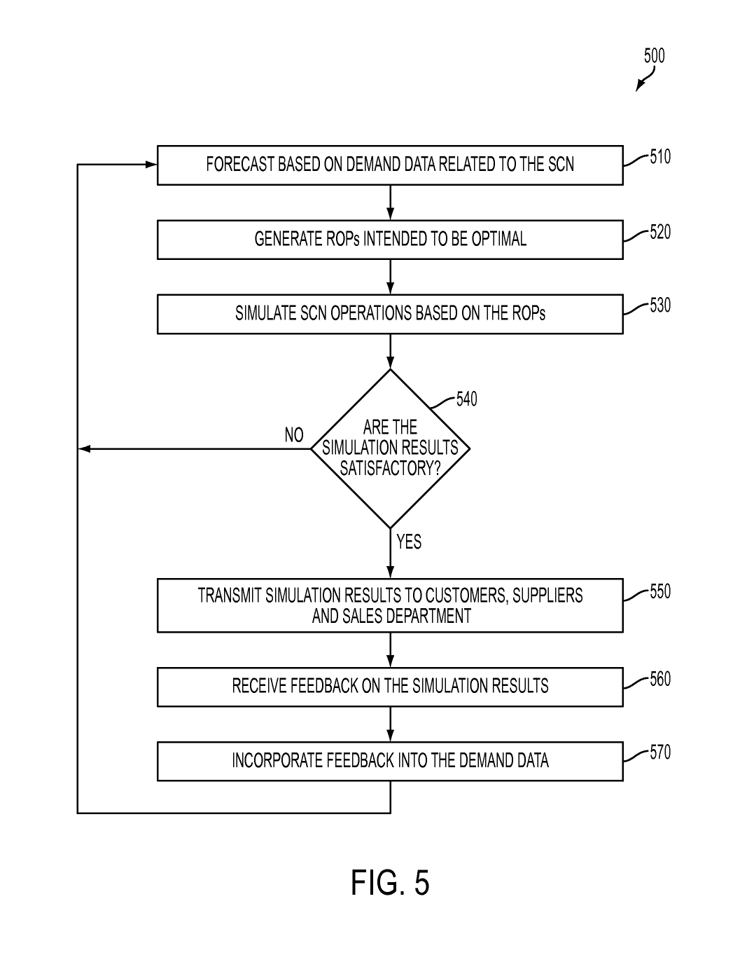

FIG. 5 illustrates a flow diagram of an example method 500 for attempting to optimize an SCN. At block 510, various data related to the SCN may be forecast based on current demand data. At block 520, the forecasted data is analyzed to generate a set of ROPs currently deemed to be optimal. In some embodiments, generating the set of ROPs may be performed simultaneously with determining a worst-case scenario for the demand forecast. At block 530, a simulation is performed based on the ROPs, to output simulation results. At decision block 540, it is determined whether the simulation results meet a set of predetermined conditions. If the predetermined conditions are not met, then the method 500 returns to block 520 for another attempt at optimizing the ROPs. Alternatively, if the predetermined conditions are met, then at block 550, the simulation results are transmitted to various entities, e.g., customers, suppliers, and the sales department. At block 560, feedback is received from the various entities regarding the simulation results. At block 570, that feedback is incorporated into the demand data for future ROP generation. The method 500 then returns to block 510 to begin generation of a new set of ROPs based on the current demand data. It will be understood that only future ROPs are generated according to the above method 500. When an ROP becomes present, the reorder activities may then be performed, moving that particular ROP from the set for future ROP generation.

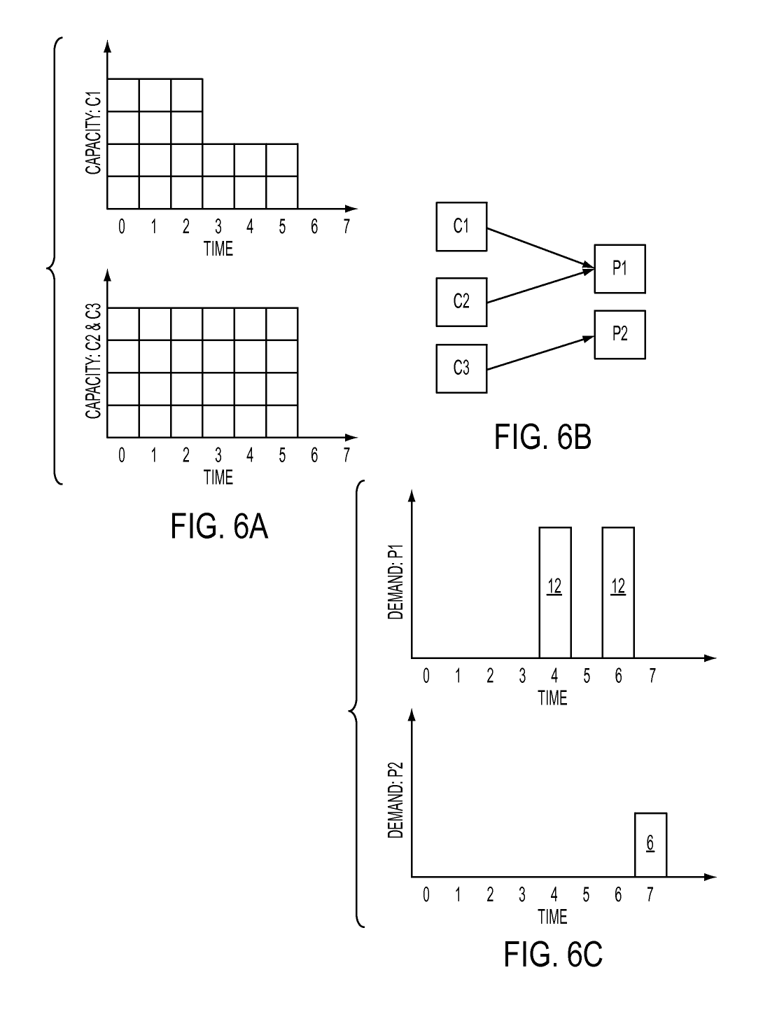

FIGS. 6A-11 are tables illustrating results of attempting to optimize an SCN using four different techniques, one of which being an exemplary embodiment of this disclosure.

FIGS. 6A-6C show various guidelines for the SCN being optimized. Specifically, FIG. 6A illustrates time-dependent capacity restrictions on individual components, C1, C2, and C3, being produced. As shown, at Times 0, 1, 2, 3, 4, 5, 6, and 7, the units of Component C1 that can be produced are respectively 4, 4, 4, 2, 2, 2, 0, and 0, and the combined units of Components C2 and C3 that can be produced are respectively 4, 4, 4, 4, 4, 4, 0, and 0. FIG. 6B illustrates what components are needed to make two products, P1 and P2. Specifically, Components C1 and C2 are needed in equal parts to produce Product P1, and Component C3 is needed to produce Product P2. FIG. 6C illustrates the forecasted demand for these products, showing that 12 units of Product P1 are expected to be demanded at each of Times 4 and 6, and 6 units of Product P2 are expected to be demanded at Time 7.

It is assumed that external demand for the end products, P1 and P2, is immediately propagated to the components, C1, C2, and C3, so the focus of these tables is set on the components. The optimization system 200 may seek to minimize the backlog of the components. Demand for Product P1 can be satisfied only if there is enough stock available of both Components C1 and C2. It is further assumed that Components C2 and C3 follow either a first-in-first-out (FIFO) scheduling rule where C2 is preferred if the situation is indifferent, or a fair-share scheduling rule where the total capacity is assigned according to the total demand.

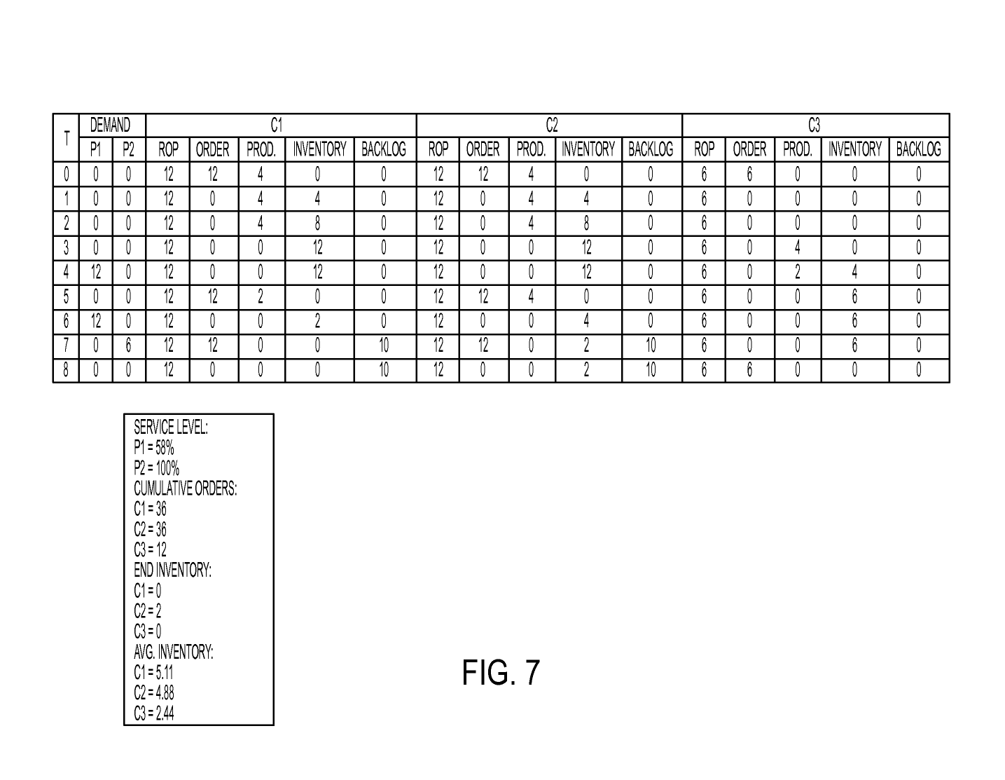

Based on the SCN parameters show in FIGS. 6A-6C, FIG. 7 illustrates a capacity-constrained simulation using results from an optimization that assumes no capacity constraints on total production (i.e., production of all components combined), using a constant ROP, and where component orders are processed in a FIFO manner. In this case, the ROP is constant and thus not time-dependent. In this example, the resulting optimization based on these parameters is a suggested ROP of 12 units for each of Components C1 and C2 and an ROP of 6 units for Component C3. Thus, whenever inventory is below 12 units for either of Components C1 or C2, an order is placed to bring inventory back to that level, and likewise for 6 units of Component C3.

As shown, at Time 0, current inventory of each component is 0 units, so orders are placed for 12 units of Component C1, 12 units of Component C2, and 6 units of Component C3. Because of the FIFO processing, the orders for Components C1 and C2 are addressed first, and the order for Component C3 will have to wait because Components C2 and C3 have a shared capacity restriction. Thus, at Time 0, 4 units of Component C1 and 4 units of C2 are produced. Because of the capacity restrictions on the individual component production (as shown in FIG. 6A), no more than these units may be produced at Time 0. At Times 1 and 2, again, 4 units of each of Components C1 and C2 are produced, and the inventory of these components grows accordingly.

At Time 3, all of the ordered units of Component C2 have been produced, so instead 4 units of Component C3 are produced, based on the order placed back at Time 0. The ordered units of Component C1 have also been produced in full, so no more units of that component are produced at Time 3.

At Time 4, the expected demand for 12 units of Product P1 is received, and as a result, the 12 units of each of Components C1 and C2 required for Product P1 are removed from inventory by Time 5. Also at Time 5, new orders are placed for Components C1 and C2 based on the constant ROPs for those components. As many units as possible, given the capacity restrictions on those components, are produced at that time.

At Time 6, a demand is received for another 12 units of Product P1. Based on current inventory, however, only 2 units of Product P1 can be supplied since only 2 units of Component C1 are in inventory. Accordingly, there is a 10-unit backlog for each of Components C1 and C2 at Time 7. Also at Time 7, a demand is received for 6 units of Product P1, which is fulfilled based on the inventory of Component C3 as no other components are needed for Product P2.

Accordingly, as shown in the box in the lower left of FIG. 7, the service level of Product P1 for this optimization is 58%, and the service level for Product P2 is 100%.

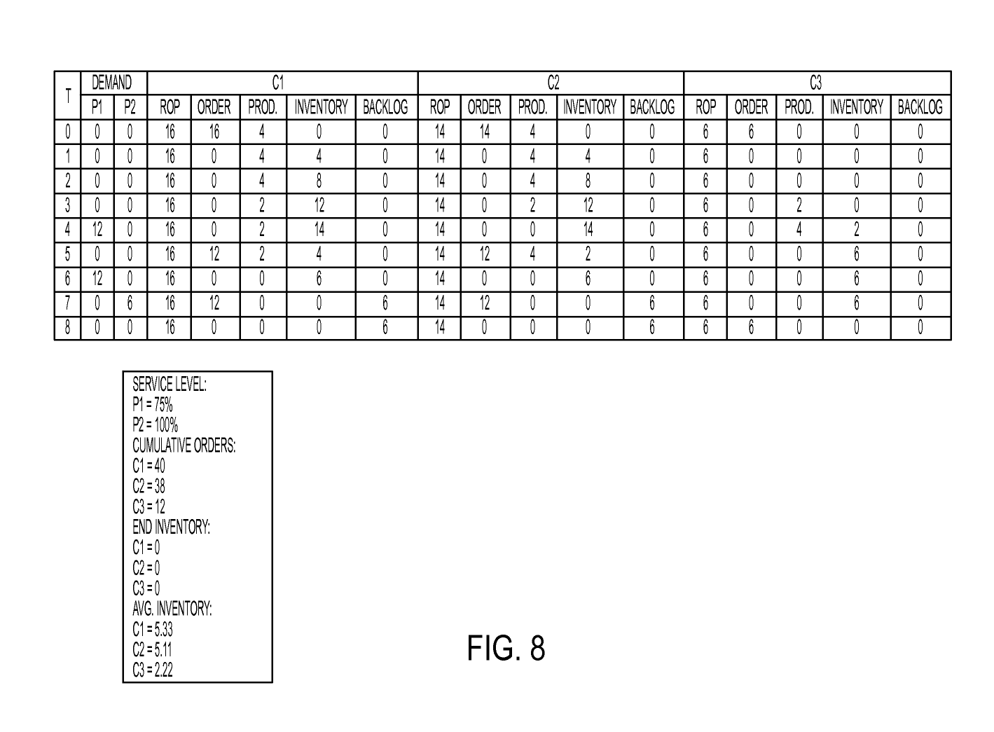

Based on the SCN parameters show in FIGS. 6A-6C, FIG. 8 illustrates a capacity-constrained simulation using the results of an optimization that assumes capacity constraints on the total amount of production at a given time, using a constant ROP, and where component production orders are processed in a FIFO manner. In contrast, while the simulation of FIG. 7 enforced capacity restrictions on individual products, it was assumed that there was no capacity constraint on entire production. This is changed in FIG. 8. As a result of this change, the optimized ROP was deemed to be higher. This higher ROP ended up improving the service level for Product P1, which is 75% in FIG. 8 as opposed to 58% in the simulation of FIG. 7. The service level for Product P2 remains the same at 100%.

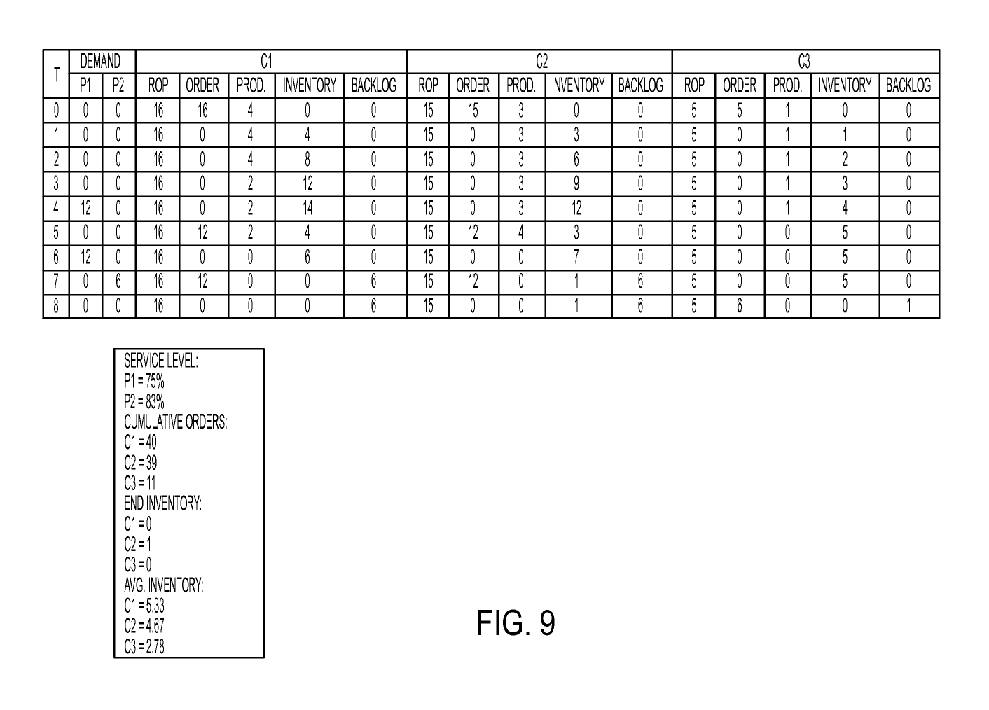

Based on the SCN parameters show in FIGS. 6A-6C, FIG. 9 illustrates a capacity-constrained simulation using the results of an optimization that assumes capacity constraints on the total amount of production at a given time, using a constant ROP, and where component production orders are processed in a fair-share manner as opposed to FIFO. In other words, in contrast to the simulation of FIG. 8, processing component production orders does not give higher priority to the production orders deemed to be first; rather, resources are shared during processing. As a result of this change from FIG. 8, some units of each of Components C2 and C3 are being produced at Times 0-2, instead of production for Component C3 being postponed entirely. The result is a lower service level for Product P2 of 83%, and a Product P1 service level of 75% again.

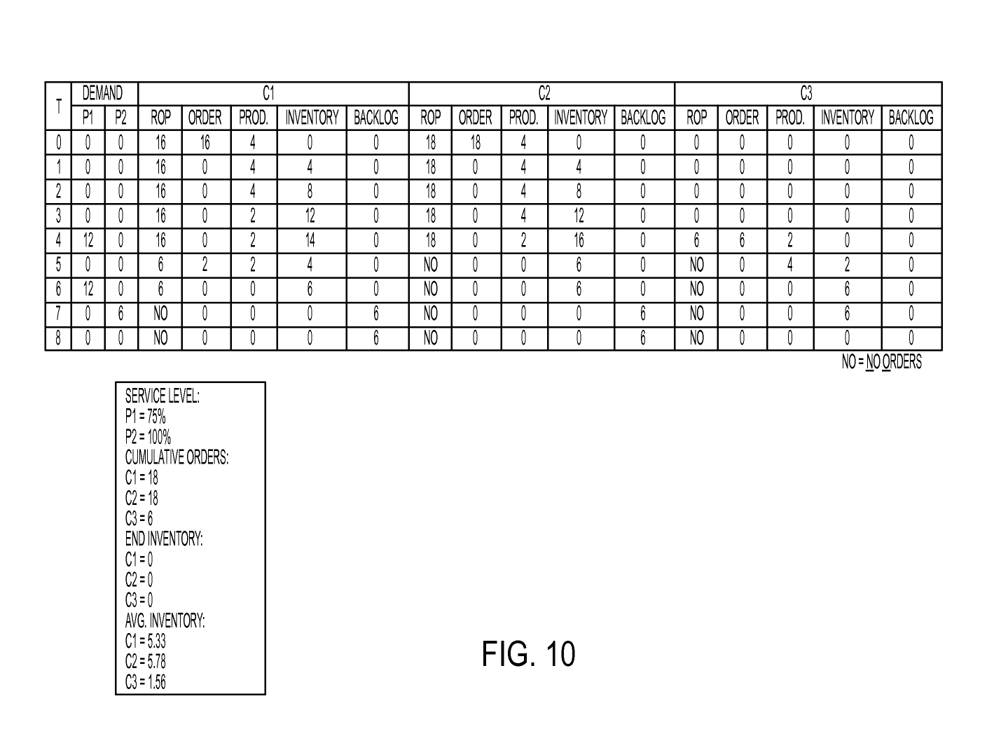

Based on the SCN parameters show in FIGS. 6A-6C, FIG. 10 illustrates a capacity-constrained simulation that may result from an optimization system 200 according to an exemplary embodiment of this disclosure. In this example simulation, time-dependent ROPs are used, with a capacity constraint on total production, where component production orders are processed in a FIFO manner. Because the ROPs need not be fixed, a higher ROP value may be used in the early periods, which may be reduced later. At the end of the simulation, as shown in FIG. 10, the service level for Product P1 is 75% and the service level for Product P2 is 100%.

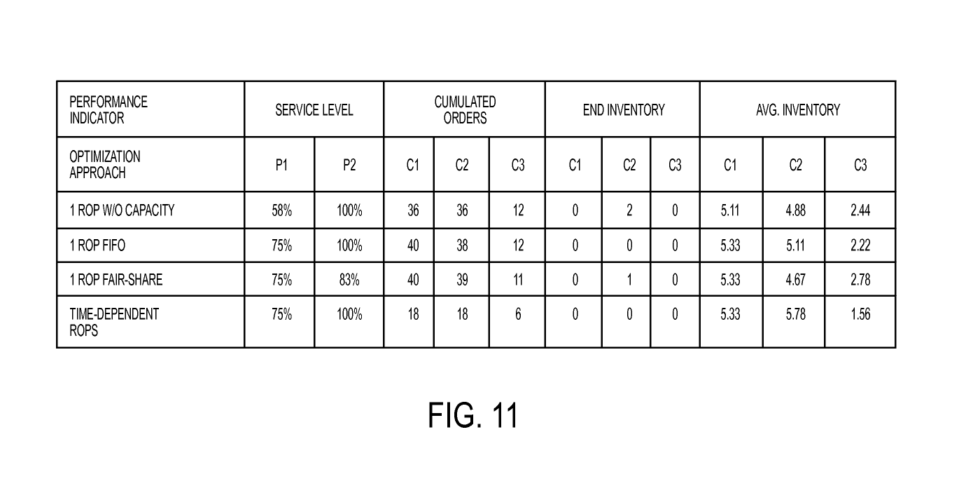

FIG. 11 is a table summarizing the results of the simulations represented in FIGS. 7-10. As shown, the simulation with fixed ROPs and FIFO (FIG. 8) and the simulation with time-dependent ROPs according to an exemplary embodiment of this disclosure (FIG. 10) achieved the highest service levels. Additionally, however, the simulation with time-dependent ROPs achieved those service levels even though a fewer number of component orders were placed. In these examples, the simulation with time-dependent ROPs matches ordered quantity and total demand perfectly. While this may not make a difference in the short term, if the optimization system 200 were analyzed for a longer term, all product orders would be fulfilled at some point with less waste. While in contrast, the simulations that ordered greater quantities than needed would increase the inventory cost or waste capacity that would be better used for other products.

Accordingly, as shown by comparing the above examples, time-dependent ROPs generated through optimization according to some exemplary embodiments of this disclosure can improve on conventional SCN optimization.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
forecasting demand in a supply chain network (SCN) based on a set of demand data;
generating, by a computer processor, one or more time-dependent reorder points (ROPs) for the SCN based on the demand forecast, wherein each time-dependent ROP represents an ROP that changes over time; and
performing a simulation of operations in the SCN using the time-dependent ROPs.

2. The method of claim 1, further comprising:
determining whether a result of the simulation meets a predetermined condition; and
repeating generating the time-dependent reorder points and the simulation until the predetermined condition is met.

3. The method of claim 1, further comprising:
transmitting at least a portion of a result of the simulation to a third party; and
receiving feedback from the third party regarding the result of the simulation.

4. The method of claim 3, further comprising:
updating the demand data by incorporating at least a portion of the feedback into the demand data; and
repeating the forecasting, generating, and performing based on the updated demand data.

5. The method of claim 4, wherein updating the demand data comprises updating a demand model according to a difference between the simulation results and an actual demand indicated by the third party.

6. The method of claim 1, wherein generating the time-dependent ROPs is performed while calculating a worst-case potential error.

7. The method of claim 1, further comprising determining an ROP period, wherein updating of the time-dependent ROPs is restricted based on the ROP period.

8. A computer program product comprising a computer readable storage medium having computer readable program code embodied thereon, the computer readable program code executable by a processor to perform a method comprising:
forecasting demand in a supply chain network (SCN) based on a set of demand data;
generating, by a computer processor, one or more time-dependent reorder points (ROPs) for the SCN based on the demand forecast, wherein each time-dependent ROP represents an ROP that changes over time; and
performing a simulation of operations in the SCN using the time-dependent ROPs.

9. The computer program product of claim 8, the method further comprising:
determining whether a result of the simulation meets a predetermined condition; and
repeating generating the time-dependent reorder points and the simulation until the predetermined condition is met.

10. The computer program product of claim 8, the method further comprising:
transmitting at least a portion of a result of the simulation to a third party; and
receiving feedback from the third party regarding the result of the simulation.

11. The computer program product of claim 10, the method further comprising:
updating the demand data by incorporating at least a portion of the feedback into the demand data; and
repeating the forecasting, generating, and performing based on the updated demand data.

12. The computer program product of claim 8, wherein forecasting demand in the SCN based on the set of demand data comprises calculating a worst-case potential error, the method further comprising assuming the worst-case potential error occurs at one or more specific times, excluding one or more other specific times.

13. The computer program product of claim 8, the method further comprising determining an ROP period, wherein updating of the time-dependent ROPs is restricted based on the ROP period.
